(19) United States
(12) Patent Application Publication
(10) Pub. No.: US 2025/0370953 A1
(43) Pub. Date: Dec. 4, 2025

(54) SERIAL BUS SYSTEM

(71) Applicant: Infineon Technologies AG, Neubiberg (DE)

(72) Inventors: Rainer FINDENIG, Linz (AT); Andreas GEILER, München (DE); Thomas FRITZ, Groß St. Florian (AT); Bernhard GRESLEHNER-NIMMERVOLL, Hagenberg (AT); Thomas LANGSCHWERT, Kirchheim (DE)

(21) Appl. No.: 19/214,724

(22) Filed: May 21, 2025

(30) Foreign Application Priority Data
May 28, 2024 (DE) 102024204975.1

(51) Int. Cl. G06F 13/42

(52) U.S. Cl. CPC G06F 13/4282; G06F 2213/0008

(57) ABSTRACT

A responder bus node includes a communication interface and a processor unit. The communication interface is configured to receive a data frame from a commander bus node and send a stored response data frame to the commander bus node. The processor unit is configured to evaluate the data frame in order to determine a command and a message index, and execute a function identified by the command, with this function providing one or more data words as a function response if the command is not a no operation command. The processor unit is configured to produce a new response data frame having a header field, containing the message index, and a payload field containing at least the function response, update the stored response data frame with the new response data frame, and output a logic signal indicating that the stored response data frame is ready for transfer.

### CROSS-REFERENCE TO RELATED APPLICATION

This application claims priority to Germany Patent Application No. 102024204975.1 filed on May 28, 2024, the content of which is incorporated by reference herein in its entirety.

### TECHNICAL FIELD

This description relates to the field of serial bus systems, for example for the configuration of sensors and other electronic components.

### BACKGROUND

Serial data communication is used in a multiplicity of applications. In this regard, for example, data can be transferred using serial data transfer between two chips arranged on a circuit board, between two circuits within the same chip or else between two separate electronic control units (ECUs). A wide variety of standardized serial bus systems are known (in some instances also proprietary standards). For example, SPI (Serial Peripheral Interface), also known as SPI bus, is widely used. A bus typically comprises multiple signals and/or lines for communication between two bus nodes. In the case of an SPI those include a shift clock signal and an activation signal (often also designated as chip select or slave select signal). These two signals determine the data transfer rate of the serially transferred data and the time windows in which data are transferred.

In addition to the bus lines, a bus system also comprises a bus protocol which specifies how the transferred data are structured. In the case of SPI frames, data are typically transferred in data frames, with each frame being able to have a header field and a payload field. To transfer data between a commander bus node (also called a master) and a responder bus node (also called a slave), an address can be specified in the header field. This address may be a read address which designates a memory location from which data is to be read in the responder bus node and then transferred to the commander bus node. This address may also be a write address which designates a memory location to which data sent from the commander bus node to the responder bus node is to be written. An address does not necessarily refer to a memory cell of a memory, but may also address another component, such as an analog-to-digital converter, a digital-to-analog converter, a sensor, etc.

The payload field contains the data to be read/written. It may also contain a checksum, such as a CRC checksum, which is determined using a cyclic redundancy check (CRC).

Serial data transfer using SPI usually follows a request/response scheme. This means that the commander bus node sends a data frame as a request to the responder bus node and the responder bus node responds with a data frame whose content depends on the content of the request. In the case of a read request, the commander bus node sends a data frame with the read address to the responder bus node and the responder bus node responds with a data frame containing the read data. In the case of a write request, the commander bus node sends a data frame with the write address (in the header field) and the data word to be written (in the payload field) to the responder bus node and acknowledges the execution of the write operation with a data frame which may contain an error code, for example.

The request/response scheme discussed above is also referred to as “polling” and implies a relatively large overhead in data transfer which may be between 50 and 75 percent of the transferred payload. Although the use of CRC checksums enables transmission errors to be detected, the request/response scheme must be repeated in full in the event of an error, which also results in redundant data transfers. In addition, a problem arises when the response in the responder bus node takes a certain amount of time to be generated and it is not possible to send a response with the requested data immediately in response to the request. The commander bus node must then repeat its request without knowing exactly when the desired response is available for transfer in the responder bus node.

The inventors have set themselves the task of improving existing concepts for data transfer.

### SUMMARY

The above-mentioned object is achieved by the bus nodes as claimed in claims 1 and 10, as well as the methods as claimed in claims 9 and 14 and the system as claimed in claim 18. The subject matter of the dependent patent claims contains various example implementations and further developments.

The following text describes a responder bus node. According to one example implementation, the responder bus node includes a communication interface and a processor unit. The communication interface is configured to receive a data frame from a commander bus node and to send a stored response data frame to the commander bus node. The processor unit is configured to evaluate the received data frame in order to determine a command and a message index based on the data frame and to execute a function identified by the command, with this function providing one or more data words as a function response if the command is not a no operation command. The processor unit is further configured to produce a new response data frame having a header field containing at least the message index and having a payload field containing at least the function response, to update the response data frame stored in the communication interface with the new response data frame and to output, at an output, a logic signal indicating that the stored response data frame is ready for transfer.

A commander bus node is also described. According to one example implementation, the commander bus node includes a communication interface and a controller circuit. The communication interface is configured to send a stored data frame, containing a command and a message index, to a responder bus node and to receive a response data frame from the responder bus node. The controller circuit is configured to receive, at an input, a logic signal indicating that the responder bus node is ready to transfer the response data frame, and to output a selection signal via the communication interface so as to cause the responder bus node to start the transfer of the response data frame.

Another example implementation relates to a system having multiple bus nodes. In one example implementation, the system includes a commander bus node and a responder bus node and a plurality of bus lines connecting a communication interface of the commander bus node to a communication interface of the responder bus node. The system further includes an additional signal line for data flow control, which connects the communication interface of the commander bus node to the communication interface of the responder bus node. The responder bus node is configured to output to the additional signal line a logic signal indicating that a data frame is ready for transfer, and the commander bus node is configured to start a data transfer based on the logic signal.

Further example implementations relate to methods for the commander and responder bus nodes.

### BRIEF DESCRIPTION OF THE DRAWINGS

Example implementations are described in greater detail below with reference to figures. The representations are not necessarily to scale, and the example implementations are not restricted just to the represented aspects. Rather, emphasis is placed on presenting the principles underlying the example implementations. In the figures:

FIG. 1 illustrates an example of a simple SPI bus system having a commander bus node (SPI master) and a responder bus node (SPI slave).

FIG. 2 illustrates an example of the structure of the responder bus node from FIG. 1 in more detail.

FIG. 3 is a timing diagram illustrating the bidirectional, simultaneous and synchronous transfer of data frames between the commander bus node and the responder bus node (request-response scheme).

FIG. 4 illustrates the structure of the data frames from FIG. 3.

FIG. 5 illustrates an example of a modified structure of a data frame according to one example implementation.

FIG. 6 illustrates a responder bus node (and its connection to the commander bus node) according to one example implementation.

FIGS. 7 and 8 are flow diagrams regarding the function of the commander and responder bus nodes for illustrating the bus communication.

FIG. 9 illustrates a timing diagram of the control of the data flow between the commander and responder using the RFT signal line.

FIG. 10 illustrates an example of a request-response scheme without transfer errors.

FIGS. 11 to 13 illustrate the effect of individual transfer errors in the request-response scheme from FIG. 10.

FIG. 14 illustrates the effect of multiple transfer errors in the request-response scheme from FIG. 10.

FIG. 15 illustrates a full-duplex transfer according to the example implementations described here.

### DETAILED DESCRIPTION

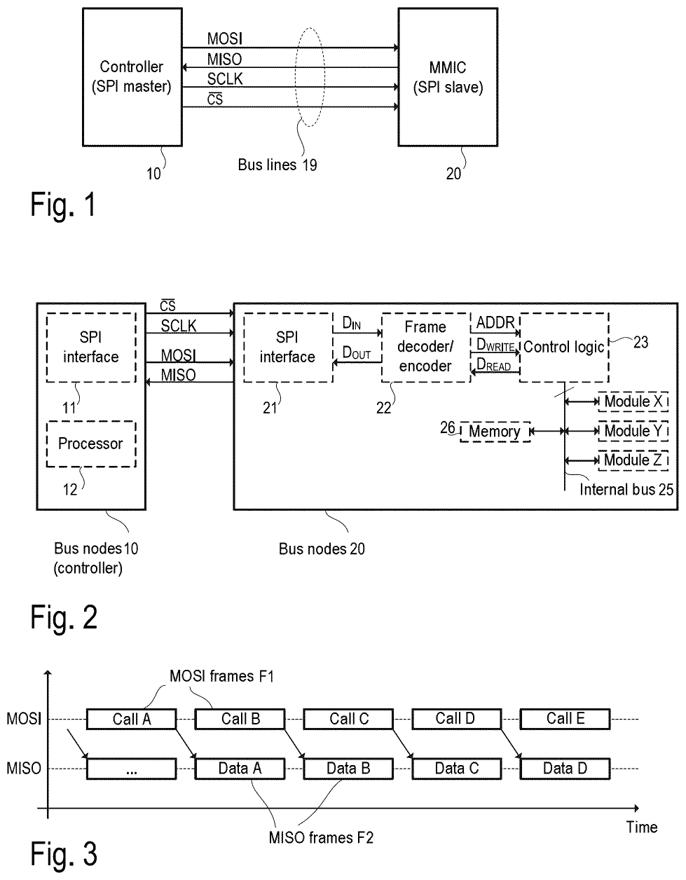

FIG. 1 shows very generally a bus system having a commander bus node 10 (SPI master, commander for short) and a responder bus node 20 (SPI slave, responder for short). The commander 10 and the responder 20 are connected using the bus lines 19. In the example shown, four bus lines are used for bidirectional, simultaneous and synchronous data transfer (full-duplex operation). The bus lines 19 comprise the data lines MOSI and MISO, the clock line SCLK and the activation line CS (chip select). The signals transferred via these lines are referred to by the same acronyms. The chip select signal is often referred to as C̅S̅, where the overline indicates a negation, e.g., a “0” indicates the activation of the data transfer. The responder bus node may be a radar monolithic microwave integrated circuit (MMIC).

The data is transferred serially from the commander 10 to the responder 20 via the data line MOSI (Master Out—Slave In); the data is transferred serially in the other direction via the data line MISO (Master In—Slave Out). The data is transferred in sync with the clock signal generated by the commander 10 and received by the responder 20 via the clock line SCLK. The start and end of a data transfer (e.g., of a data frame) is indicated using the activation signal (logic signal) transferred via the line CS, which signal is also generated by the commander 10.

FIG. 1 illustrates an example of a system having two bus nodes connected via an SPI bus. However, the example implementations described here are not limited to an SPI bus, but the concepts described below can also be applied to any other serial bus systems such as HSSL (High-Speed Serial Link), MSB (Microsecond Bus), I2C bus (Inter-Integrated Circuit Bus) or the like.

The commander bus node 10 shown in FIG. 2 is also referred to in the following text as controller, since it controls the bus communication. The bus node 10 may, for example, be a microcontroller having an SPI interface 11 and at least one processor 12 which is configured to execute software instructions contained in a memory in order to implement the concepts, functions and method steps described here. Programmable microcontrollers having an SPI interface are known per se and are therefore not described in more detail here. However, it is understood that the bus node 10 does not necessarily have to have a processor for executing software instructions. In addition or as an alternative, hard-wired or one-time programmable (OTP) logic can also be used. A mixture of programmable processor and hard-wired logic is also often used.

The SPI interface 11 of the bus node 10 is connected to a corresponding SPI interface 21 of an additional bus node 20 via multiple bus lines which are designated by C̅S̅, SCLK, MOSI and MISO in the case of an SPI bus. The signals transferred via the respective bus lines are also designated by C̅S̅, SCLK, MOSI and MISO. The commander bus node 10 specifies the times at which frames are sent (by activating C̅S̅) and also the data transfer rate (generation of SCLK). In addition, the commander bus node also defines whether data are to be read or written.

In some applications, the signal C̅S̅can be considered optional. It is used in particular when multiple responder bus nodes are connected to a commander bus node (in this case, multiple C̅S̅ signals may be provided). C̅S̅ is essential in some applications. SCLK denotes a clock signal output by the commander bus node 10 for synchronizing the data transfer taking place on the data lines MISO and MOSI. In a full-duplex data transfer, as mentioned above, data is transferred simultaneously and in sync with the clock signal SCLK on both data lines, MOSI and MISO. It is also possible to use multiple MISO and MOSI lines simultaneously to be able to transfer more than one bit per clock cycle.

Data is usually transferred serially based on frames (MOSI frames from the commander 10 to the responder 20, MISO frames from the responder 20 to the commander 10). The structure of a frame and possible modifications will be explained in more detail later. In the responder 20, the data D_{IN} received from the SPI interface 21 is passed on to a frame decoder/encoder 22. In the other direction, the frame decoder/encoder 22 supplies the SPI interface with the data D_{OUT} to be transferred. The frame decoder/encoder 22 is configured on the one hand to “unpack” (and, if necessary, validate) the data contained in a MOSI frame and to “pack” (and, if necessary, to back up with a checksum or the like) in a MISO frame the raw data to be sent.

Validating and backing up data contained in a frame usually involves calculating or verifying a checksum. In the example implementations described here, the cyclic redundancy check (CRC) is used for calculating and verifying checksums, with other algorithms for determining and verifying checksums also being possible. In the simplest case, the checksum consists of one or more parity bits. Different CRC methods or CRC polynomials and other methods for determining and verifying checksums are known per se and are therefore not explained in detail here. In the example shown, the frame decoder/encoder 22 adds a checksum to those (raw) data D_{READ} that are packed into a frame (to be sent), and verifies the checksum contained in a (received) frame in order to check the integrity of the received data (e.g., an address ADDR, and a data word D_{WRITE}).

In the case of a write operation, the commander 10 instructs the responder 20 to write a data word D_{WRITE} to an address ADDR, e.g., to store the data word D_{WRITE} to the memory location designated by the address ADDR. To do this, the commander 10 transfers the data word D_{WRITE} and the address ADDR in a MOSI frame to the responder 20. In the case of a read operation, the commander 10 instructs the responder 20 to read data D_{REA} from an address ADDR and to transfer the read data D_{READ} to the commander 10. To do this, the commander 10 sends the address ADDR in a MOSI frame (request frame) to the responder 20, which sends the read data D_{READ} in (at least) one MISO frame (response frame) back to the commander 10. The address ADDR identifies a location in the modules (modules X, Y and Z) or memory areas (memory 26) of bus node 20 to which data can be written or from which data can be read.

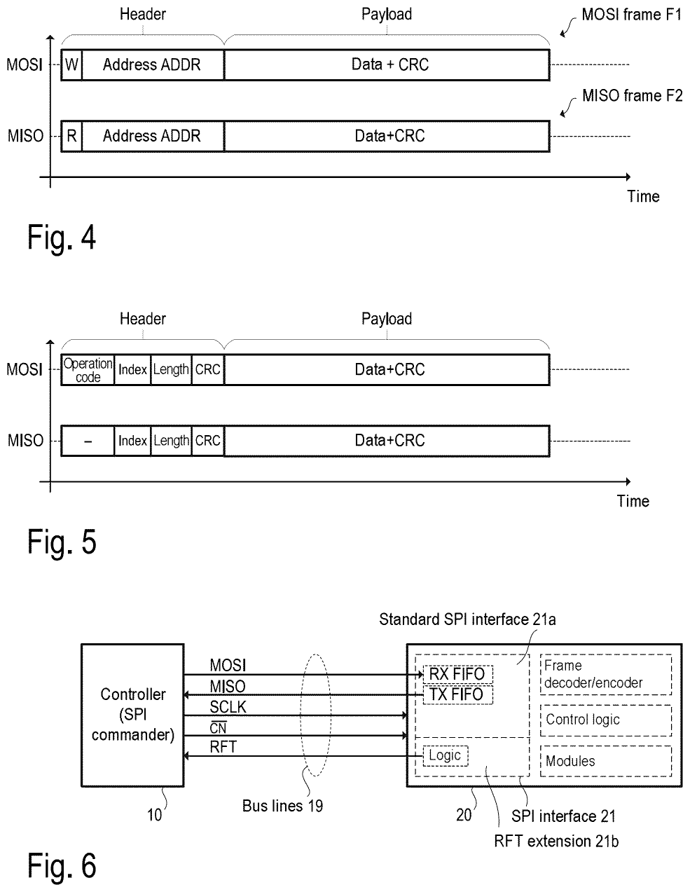

The data received in a MOSI frame in the responder bus node 20 are in the present example designated by D_{WRITE} and ADDR and are supplied to control logic 23. The data sent in a MISO frame from the responder bus node 20 are output by the control logic 23 to the frame decoder/encoder 22 and in the present example are referred to as D_{READ}. The structure of a frame and the meaning of the data contained therein will be explained in more detail later (cf. FIG. 4). The control logic 23 can, for example, access a memory 25 and/or one or more modules X, Y, Z via an internal data bus 25. A module may be any data source or data sink. A module may also be a sensor or a part of a sensor system which can be configured and controlled, e.g., with the aid of the SPI bus. For example, the sensor system may be an automotive radar system.

FIG. 4 schematically illustrates the frame-based full-duplex data transfer via a serial bus, wherein a respective sequence of frames are transferred both via the MOSI data channel and via the MISO data channel. In the example shown, the frames F1 transferred via the MOSI data channel (e.g., the data contained therein) can be interpreted as a request, for example a request to read or write data at a specific address (e.g., “write A”, “read B”, etc.). The frames F2 transferred via the MISO data channel contain the responses to the respective request (e.g., the data read from a register).

The frames F1 and F2 are transferred simultaneously and in sync with a clock signal (generated by the bus node 10 and output to the SCLK line). In the examples described here, “simultaneously” is understood to mean that the two frames (from and to the commander node) overlap at least temporally. In one example implementation, in a specific time interval in which a MOSI frame is transferred, a MISO frame is also transferred simultaneously. Particularly in the case of an SPI, the transfer is isochronous since both frames (apart from unavoidable propagation delay effects) begin and end substantially at the same point in time.

As shown in FIG. 4, each frame (MOSI and MISO frames) comprises at least one first field with header data, a second field with payload data and an (optional) third field with a checksum. The responder bus node (e.g., bus node 20) executes a specific function depending on the data contained in a MOSI frame F1. The function depends on the header data representing the request. For example, the header data designate an address (e.g., a register address) for a read or write operation. Some of the header data (in a simple case, only one bit) indicate whether a write or read operation should be executed. However, the information regarding the function/operation to be executed can also be regarded as part of the address. In the case of a write operation, the data to be written are in the payload data field of the MOSI frame F1. In the case of a read operation, the payload data of the MOSI frame F1 may also be dummy data (e.g., a sequence of zeros). The checksum in the checksum field of the MOSI frame F1 (MOSI CRC) backs up the data of the MOSI frame contained in the header field and in the payload field. For the example shown, this means that the CRC checksum (MOSI CRC) in the commander bus node 10 is calculated based on the header data and the payload data.

The rigid request-response scheme described above results in a relatively large overhead in the data transfer, especially when larger amounts of data are to be transferred from the responder bus node to the commander bus node. The commander bus node must send a separate request (polling) for each data word to be transmitted. In addition, certain applications may not have the requested data word available (e.g., because it first has to be calculated). In this case, the commander bus node must repeat the request. The overhead in the data transfer is 50-75 percent for the described request-response scheme.

The fact that the response to a read request is not yet available can occur in particular in applications in which the read request is not addressed to a simple memory, but rather a functional unit of the responder bus node containing the current data to be transferred in the response must first be calculated or retrieved from another functional unit.

In order to reduce the overhead in the data transfer, the headers of the MOSI frame F1 (request frame) and the MISO frame F2 (response frame) are modified as shown in FIG. 5. The header field of a MOSI frame F1 contains at least one command (represented by an operation code) and a message index. The header field may also (optionally) contain a message length and a checksum (e.g., a CRC checksum). However, the message length may also be a fixed value in some applications. The message length refers to the number of data words in a message and thus the length (in data words) of the payload data field. The payload field of the MOSI frame F1 contains the data to be transmitted (at least one data word) and optionally a CRC checksum, which may also utilize a data word. The MISO frame F2 is essentially of the same structure as a MOSI frame F1, but the MISO frame F2 does not require a command (operation code) in the header.

The concept according to FIG. 5 does not require a large address space. The command (operation code), which the commander bus node 10 sends to the responder bus node in a request frame, identifies a function (e.g., a hardware function) that the responder bus node executes and which provides one or more data words as a function response. The command may also be a no operation command (NOP) which does not provide a function response. The meaning of the no operation command will be explained in more detail later.

The responder bus node 20 sends the function response as a “message” to the commander bus node 10, where the message can contain multiple data words in the payload field (corresponding to the length specified in the header). The response data frame F2 contains the message index that was previously transferred to the responder bus node 20 in the associated request data frame F1. The message index enables the commander bus node 10 to assign the response message (a response data frame F2) to a specific request. This means that a response message can be temporally decoupled from the associated request. The message indices contained in the received response messages enable the commander bus node 10 to identify the respective MISO frames F2 as responses to specific requests.

In order to avoid the unnecessary transfer of request frames by way of the commander bus node, according to one example implementation, the bus interface 21 of the responder bus node 20 may be configured to output, at an output (connected to the signal line RFT, Ready For Transfer), a logic signal indicating that a new response data frame (a new response message) is ready for transfer. The signal line RFT connects the output of the responder bus node 20 to an associated input of the commander bus node 10. If the responder bus node 20 signals via the signal line RFT that a new message is ready for transfer in response to a previous request, the commander bus node 10 can begin data transfer in response to this. An example of a system with this RFT extension is shown in FIG. 6.

In FIG. 6, the commander bus node 10 may, for example, be a common microcontroller with a standard SPI interface. The signal line RFT can be connected to a digital input of the microcontroller, for example a GPIO (General Purpose Input/Output) pin of the microcontroller. The responder bus node 20 contains a communication interface with a standard SPI interface 21a and the mentioned RFT extension 21b. In the example shown, the standard SPI interface 21a contains two FIFO (First In First Out) memories, one for received data frames (RX FIFO) and one for data frames to be sent (TX FIFO).

The responder bus node 20 further contains a frame decoder/encoder configured to extract the information contained in the received MOSI data frames (operation code, message index, if appropriate message length and checksum and payload data) and generate the MISO data frames (header and payload fields) to be sent. The responder bus node 20 further contains one or more modules which can execute at least one function assigned to a command (operation code) and provide one or more response data words as a function response. A module may therefore be a hardware function unit, where the respective function is called by a specific command.

The control logic of the responder bus node 20 shown in FIG. 6 controls the data flow between the individual components of the responder bus node 20 analogously to the example shown in FIG. 2. The control logic may be a finite state machine which can be implemented, for example, with the aid of a processor which retrieves and executes software instructions (firmware) from a memory. However, the control logic may also be a hard-wired or one-time programmable logic circuit. The RFT extension 21b contains a logic circuit whose task is to output a logic signal on the signal line RFT as soon as a module has generated a new function response. For this purpose, the logic circuit of the RFT extension 21b can receive information from the modules using the generation of a new function response. As mentioned, the flow of information can be controlled by the control logic.

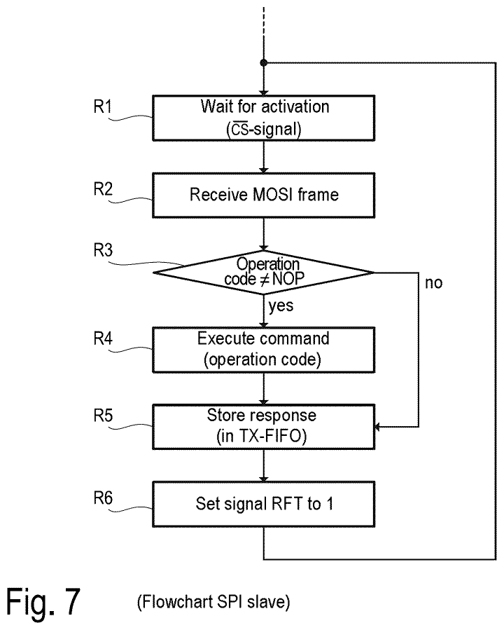

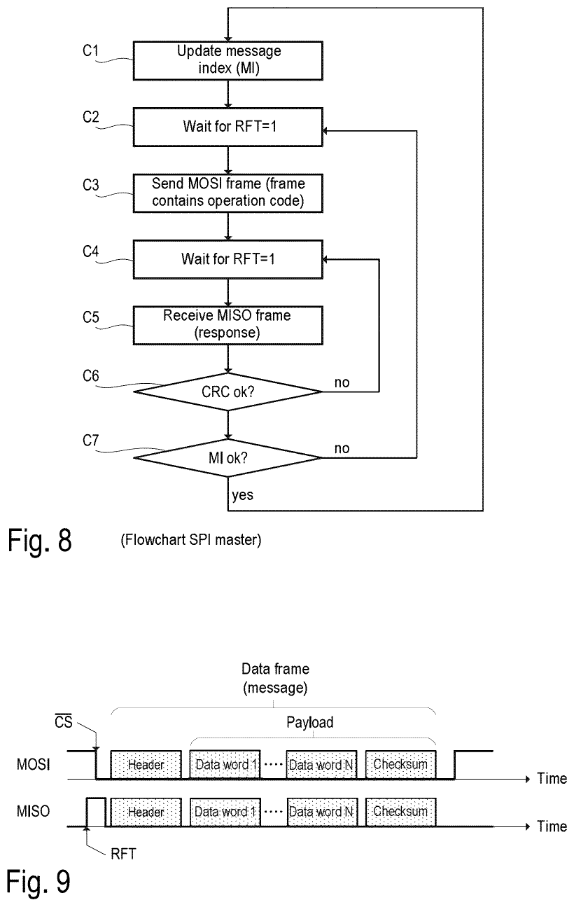

FIGS. 7 and 8 are flow diagrams for illustrating the bus communication between the commander and responder bus nodes. FIG. 7 illustrates an example of the bus communication from the viewpoint of the responder bus node 20 (see also FIG. 6). Initially, the responder bus node 20 waits for activation by the commander bus node 10. For example, the commander bus node 10 generates a chip select signal C̅S̅ with a low level and the responder bus node 20 “sees” this low level (FIG. 7, step R1). The responder bus node 20 then receives (e.g., using its SPI interface 21a, see FIG. 6) a MOSI frame (FIG. 7, step R2) which is decoded by the frame decoder (see FIG. 6) in order to extract the information contained therein, in particular the operation code, the message index and, if applicable, the length of the message and the payload data and the associated checksums. The frame decoder may also be configured to validate the received data using the checksum and to report an error if validation fails.

When data are received correctly, the responder bus node 20 executes the function defined by the operation code (FIG. 7, step R4), provided that the operation code is not a no operation command (NOP) (FIG. 7, step R3). The respective function call activates, for example, the associated module of the responder bus node 20, which then produces the function response. The function response is stored in a register, for example in the TX-FIFO of the SPI interface 21a (FIG. 7, step, R5). The frame encoder can supplement the header data (particularly the message index) so that a complete MISO frame is stored in the TX-FIFO. The responder bus node 20 signals to the bus commander with the aid of the RFT extension 21b that a new data word is available for collection (FIG. 7, step R6), for example by outputting a high level on the signal line RFT (RFT=1). After the next data transfer is activated, the MISO frame is transferred to the commander bus node (simultaneously with the reception of the next MOSI frame).

FIG. 8 illustrates an example of the bus communication from the viewpoint of the commander bus node 10. It goes without saying that, depending on the specific application, the processes in a controller may also be significantly more complex in practice. That is to say, FIG. 8 illustrates only a simple example and does not contain all the steps that may occur in a practical application. To send a new request (request message), a new, current message index (MI) is first generated (FIG. 8, step C1) and a corresponding data frame (e.g., MOSI frame with operation code, message index, if appropriate message length, payload data and checksum) is created. The commander bus node 10 waits for a new transfer until the responder bus node 20 uses the RFT signal (RFT=1) to indicate that new data can be retrieved (FIG. 8, step C2). If this is the case, the request/MOSI frame is transferred (FIG. 8, step C3, corresponds to FIG. 7, step R2). The commander bus node 10 waits until the responder bus node has produced a new response message and indicates this using the RFT signal (RFT=1, FIG. 8, step C4). If this is the case, the commander bus node 10 receives the response data frame (MISO frame), e.g., the commander bus node 10 retrieves the MISO frame (FIG. 8, step C5). However, the transfer of the MISO frame, initiated by the controller, will not be executed until the current response data frame is actually present (and the responder indicates this by way of the RFT signal).

After receiving the response frame, the commander bus node 10 can validate the received data, e.g., using checksum calculation (FIG. 8, step C6). If the validation fails, the MISO frame is retrieved again (FIG. 8 steps C4 and C5). If the validation is successful, the message index is checked (FIG. 8, step C7). That is to say the commander bus node 10 checks whether the message index in the received response frame matches the message index of the previously sent request frame. If this is the case, the process can be repeated with a new updated message index and a new request. If this is not the case, the request is sent again with the same message index (FIG. 8, steps C2 and C3), since the request was obviously not received correctly by the responder bus node 20 before (for example due to incorrect data transfer or for some other reason).

FIG. 9 illustrates a timing diagram of the control of the data flow between the commander and responder using the RFT signal line. A new data transfer (the transfer of a message) is enabled/initiated by the responder bus node 20, e.g., by outputting a high level on the RFT signal line. The commander bus node 10 sees the logic level RFT=1 and then starts the data transfer by outputting a low level on the chip select bus line, whereupon a frame (a message) is transferred in sync with the clock signal SCLK (not shown in FIG. 9). The number of data words in the payload field of a message can be specified by the length information in the header (see FIG. 5). As an alternative, the message length for a specific application may also be fixed (e.g., four data words per message, e.g., one data word header, two data words payload data and one data word checksum). For example, the size of a data word may be 8 or 12 bits.

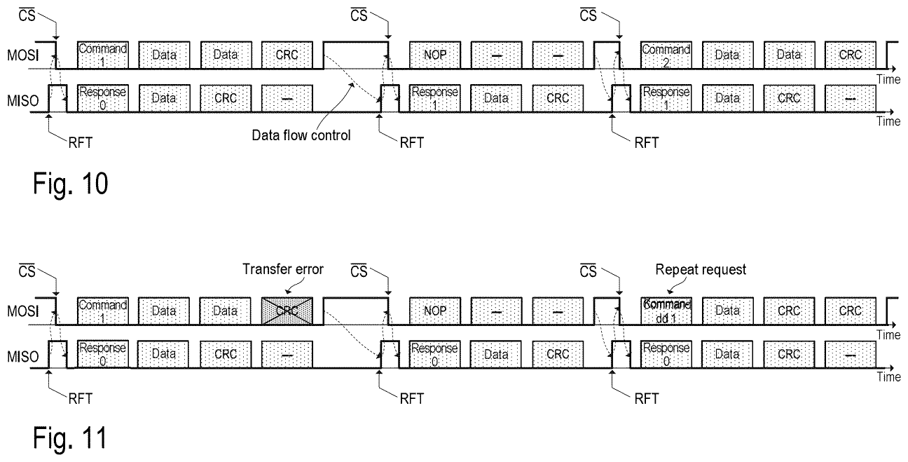

Using additional timing diagrams, the following text explains how the concept described here can be used to detect and efficiently repeat erroneous data transfers. FIG. 10 shows the standard case without transfer errors. In the example shown, in response to RFT=1, the commander bus node 10 sends a request message with a length of four (four data words), the first data word being the header and containing a command (referred to as “Command 1”), a message index (MI=1) and the message length (four data words). The payload field of the first message contains data associated with the command (two data words) and a checksum (fourth data word). The responder bus node 20 receives the MOSI frame while sending a response (“Response 0”) to a previous request (with MI=0) in the MISO frame transmitted in parallel therewith. After completion of the transfer, the commander bus node 10 sets the chip select signal back to a high level. The MISO frame does not have to be the same length. In the example shown, the message with the “Response 0” contains only three data words, which is why the fourth data word may contain dummy data (e.g., zeros) which are ignored by the receiver.

The responder bus node 20 executes a function defined by “Command 1” and takes a certain amount of time until the function response is available. As already explained above, the responder bus node 20 indicates via the RFT signal line (RFT=1) that the function response is ready for transfer. The commander bus node 10 then starts the transfer of another message, which is activated by the low level of the chip select signal. The second data transfer has a message length of three frames (header, data and checksum), where the header in the example shown contains a NOP command. This means that the responder bus node does not execute any function, but transmits an MSIO frame with the function response (“Response 1”) simultaneously to the MOSI frame, where the MSIO frame can be assigned to the request with the “Command 1” via the message index MI=1. Since the responder bus node 20 does not have to generate a new function response (due to the no operation command), the RFT signal line immediately signals the readiness for a new data transfer. In the example shown, the commander bus node then starts a new data transfer with a new message index MI=2 and a new command “Command 2”. In the absence of new response data, the responder bus node re-transfers the old “Response 1”. FIG. 10 shows that a request message with a NOP command can be used to cause the transfer of a MISO frame without a function call occurring simultaneously.

FIG. 11 shows a modification of the example from FIG. 10, namely a situation in which a transfer error occurs in the first request message (with MI=1) of the commander bus node, such that the responder bus node cannot “understand” and process the request. During validation of the transferred data, the responder bus node detects a checksum error and therefore cannot process the received data (including operation code and message index). For the second data transfer, the MISO frame does not contain the response to “Command 1” (response 1), but the actually obsolete response “Response 0” (with MI=0). When receiving the MISO frames, the commander bus node detects that the message index MI=0 of the response message does not match the message index MI=1 of the associated request message and can conclude that the responder bus node did not receive the last request correctly. For this reason, the request with message index MI=1 is transmitted again during the next data transfer (see FIG. 11, “Repeat request”).

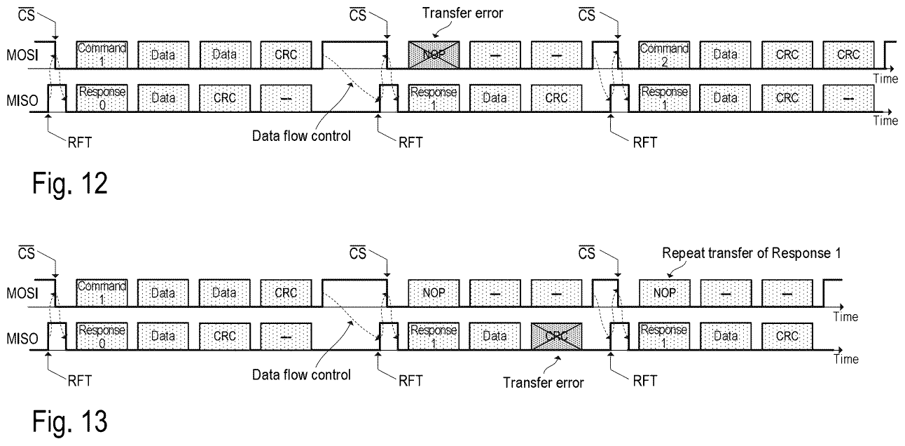

FIG. 12 shows a modification of the example from FIG. 10, namely a situation in which an error occurs in the transfer of the message containing the NOP command. The responder bus node can detect the error using the checksum contained in the header (see FIG. 5). However, as can be seen in the diagram, the fact that the no operation command was transmitted incorrectly has no effect. The responder bus node nevertheless transfers the response (“Response 1”) to the previous request with message index MI=1.

FIG. 13 shows a modification of the example from FIG. 10, namely a situation in which a transfer error occurs during the transfer of the response message with MI=1. In this case, the commander bus node can detect the error when the data are validated (checksum calculation) and repeat the message with the NOP command during the next data transfer in order to trigger another transfer of the response message with MI=1 (see FIG. 13, “Repeat transmission of Response 1”).

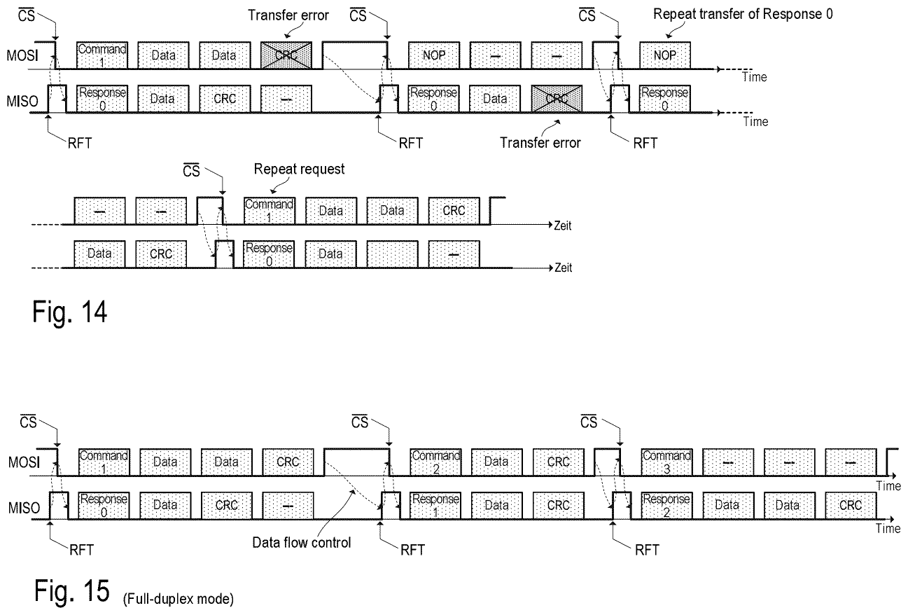

The example from FIG. 14 shows a situation with multiple transfer errors. In the example shown, in response to RFT=1, the commander bus node 10 sends a request message with four data words, the header of the MOSI frame containing a command (referred to as “Command 1”), a message index (MI=1) and the message length (four data words) (as in the example from FIG. 10). The responder bus node 20 receives the MOSI frame while sending a response (“Response 0”) to a previous request (with MI=0) in a MISO frame. After completion of the transfer, the commander bus node 10 sets the chip select signal back to a high level. The responder bus node 20 detects a transfer error during the validation of the received data (checksum calculation) and is therefore unable to execute “Command 1” and therefore does not generate a function response either.

The responder bus node 20 indicates via the RFT signal line (RFT=1) that it is ready for the next data transfer. The commander bus node 10 then starts the data transfer, which is activated by the low level of the chip select signal. The second data transfer has a message length of three data words and the header of the MOSI frame contains a NOP command. Since the request with “Command 1” and message index MI=1 was transferred incorrectly and consequently the desired function was not executed, the responder bus node transfers the obsolete function response (“Response 0”) with MI=0 again, but a second transfer error occurs. The RFT signal line then signals readiness for further data transfer. The commander bus node detects the transfer error in the response during validation/checksum calculation and therefore sends the message again with the NOP command during the next data transfer (see FIG. 14, “Repeat transfer of Response 0”), which results in a re-transfer of the obsolete function response (“Response 0”) with MI=0; this time, however, it will be transferred without error.

The commander bus node receives the repeated (but this time correct) transfer of the obsolete function response (“Response 0”) and can recognize in the message index MI=0 that does not match the request that the request has already not been transferred correctly, which is why the request is repeated with message index MI=1 during the subsequent data transfer (see FIG. 14, “Repeat request”).

In the previous examples, the response messages to requests are retrieved by transferring a NOP command. However, this is not necessarily the case. The responder bus node always transfers the message currently stored in the TX-FIFO in the MISO frames, regardless of the operation code contained in the MOSI frames. FIG. 15 shows an example of a full-duplex transmission.

During the first data transfer shown in FIG. 15, the MOSI frame contains a request with a command “Command 1” and message index MI=1. At the same time, in the MISO frame, the response “Answer 0” (with MI=0) is transferred to the previous request. During the next data transfer, the commander bus node does not send a message with a NOP command, but immediately sends a further request with “Command 2” (MI=2). At the same time, the responder bus node responds to the previously received “Command 1” with “Answer 1”. During subsequent data transfer, the commander bus node sends another request with “Command 3” (MI=3) and, at the same time, the responder bus node responds to the previously received “Command 2” with “Response 2”. MOSI frames with NOP commands are only required in the event that transfer errors occur.

The following text summarizes some aspects of the example implementations described here. This is not a complete enumeration, but rather only an example summary of technical features. One example implementation relates to a responder bus node for a serial bus system. The bus node comprises a communication interface and a processor unit. The communication interface is configured to receive a data frame from a commander bus node and to send a stored response data frame to the commander bus node. The processor unit is configured to evaluate the received data frame (e.g., with the aid of the frame decoder, see FIG. 6) in order to determine a command (operation code) and a message index based on the data frame. The processor unit is further configured to execute a function identified by the command, the function providing one or more data words as a function response (provided that the command is not a no operation command), and to produce a new response data frame with a header field containing at least the message index and a payload field containing at least the function response (or part of it). The response data frame stored in the communication interface is updated with the new response data frame and a logic signal indicating that the stored response data frame is ready for transfer is output at an output (RFT, see FIG. 6).

The processor unit may contain one or more processors or processor cores that execute software instructions (firmware) contained in a memory in order to execute the functions described here. The processor unit may at least partially also contain hard-wired and/or one-time programmable logic circuits and other peripheral components. A processor unit is any entity comprising hardware circuits and (optionally) software which is configured to execute the described functions and method steps. The components shown in FIG. 6, namely the frame decoder/encoder, the control logic, the modules/function units for executing the commands and also the RFT extension, can be understood as part of the processor unit.

In one example implementation, the communication interface of the responder bus node is configured to receive a clock signal and a selection signal (chip select signal) and to send the stored response data frame in sync with the clock signal to the commander bus node as soon as the selection signal indicates the start of a transfer (see FIG. 6, chip select signal CS and clock signal SCLK). In one example implementation, the received (MOSI) data frame may have a header field containing an operation code representing the command, the message index and a checksum. The payload field of a response data frame may also have a checksum.

The processor unit may be further configured to provide no function response when the command is a no operation (NOP) command, and to output at the output the logic signal RFT indicating that the stored response data frame is ready for (re-)transfer without this having been previously updated. The RFT signal is used to enable data flow control by way of the responder bus node and prevent unnecessary polling by way of the commander bus node.

Another example implementation relates to a commander bus node. In one example implementation, the commander bus node has a communication interface and a controller circuit. The communication interface is configured to send a stored data frame, containing a command and a message index, to a responder bus node and to receive a response data frame from the responder bus node. The controller circuit is configured to receive at an input a logic signal (see FIG. 6, signal RFT) indicating that the responder bus node is ready to transfer the response data frame. The controller circuit is further configured to output a selection signal (see FIG. 6, signal C̅S̅) via the communication interface in order to cause the responder bus node to start the transfer of the response data frame.

In one example implementation, the controller circuit may be further configured to evaluate the response data frame in order to determine a message index therefrom and to check whether the message index contained in the response data frame matches the message index contained in a previously sent data frame. If this is not the case, the data frame can be sent again with the command.

In one example implementation, the controller circuit may be further configured to evaluate the response data frame in order to determine a checksum therefrom and to check whether the checksum contained in the response data frame is correct. If this is not the case, a data frame can be sent with a no operation command to cause the responder bus node to re-send the response data frame without generating a new function response first.

The controller circuit may be part of a microcontroller and, for example, comprise a processor configured to execute software instructions stored in a memory in order to execute the functions and method steps described here. The communication interface may be a peripheral component contained in the microcontroller. The controller circuit is not necessarily software-controlled, but may also consist (partially or completely) of hard-wired or one-time programmable logic circuits. A controller circuit is any entity comprising hardware circuits and (optionally) software which is configured to execute the described functions and method steps.

Another example implementation relates to a system having multiple bus nodes. In one example implementation, the system comprises a commander bus node and a responder bus node and a plurality of bus lines connecting a communication interface of the commander bus node to a communication interface of the responder bus node. The system further comprises an additional signal line (see FIG. 6, RFT extension) for data flow control, which connects the communication interface of the commander bus node to the communication interface of the responder bus node (20). The responder bus node is configured to output to the additional signal line a logic signal indicating that a data frame is ready for transfer, and the commander bus node is configured to start a data transfer based on the logic signal. In one example implementation, the communication interfaces are standard SPI interfaces and the additional signal line enables data flow control by way of the responder bus node.

### Aspects

The following provides an overview of some Aspects of the present disclosure:

Aspect 1: A responder bus node for a serial bus system, comprising: a communication interface which is configured to receive a data frame from a commander bus node and to send a stored response data frame to the commander bus node; a processor unit configured to: evaluate the data frame in order to determine a command and a message index based on the data frame; execute a function identified by the command, wherein, if the command is not a no operation command (NOP), executing the function provides one or more data words as a function response; produce a new response data frame having a header field containing at least the message index and having a payload field containing at least the function response; and update the stored response data frame with the new response data frame and output, at an output, a logic signal indicating that the stored response data frame, having been updated with the new response data frame, is ready for transfer.

Aspect 2: The responder bus node as recited in Aspect 1, wherein the communication interface is configured to receive a clock signal and a selection signal, and to send the stored response data frame to the commander bus node in sync with the clock signal as soon as the selection signal indicates a start of a transfer.

Aspect 3: The responder bus node as claimed in any of Aspects 1-2, wherein the data frame has a header field that has an operation code representing the command, the message index, and a checksum.

Aspect 4: The responder bus node as claimed in any of Aspects 1-3, wherein the payload field of the new response data frame has a checksum.

Aspect 5: The responder bus node as claimed in any of Aspects 1-4, wherein the processor unit is further configured to, if the command is a no operation command (NOP), provide no function response, and to output, at the output, the logic signal indicating that the stored response data frame is ready for transfer without having been updated beforehand.

Aspect 6: The responder bus node as claimed in any of Aspects 1-5, wherein a separate line is connected to the output.

Aspect 7: The responder bus node as claimed in any of Aspects 1-6, wherein the communication interface has a first in first out (FIFO) memory for each transfer direction, and wherein the data frame is stored in a first FIFIO memory and the response data frame is stored in a second FIFO memory.

Aspect 8: The responder bus node as claimed in any of Aspects 1-7, wherein the responder bus node is a radar monolithic microwave integrated circuit.

Aspect 9: A method which comprises: receiving, by way of a responder bus node, a data frame from a commander bus node; evaluating the data frame in order to determine a command and a message index based thereon; executing a function identified by the command to provide one or more data words as a function response, if the command is not a no operation command (NOP); producing a new response data frame having a header field containing at least the message index and having a payload field containing at least the function response; updating a stored response data frame with the new response data frame if the command is not an NOP; outputting, at an output of the responder bus node, a logic signal indicating that the stored response data frame, having been updated with the new response data frame, is ready for transfer; and sending, by way of the responder bus node, the stored response data frame to the commander bus node.

Aspect 10: A commander bus node, comprising: a communication interface configured to send a stored data frame, containing a command and a message index, to a responder bus node and to receive a response data frame from the responder bus node; and a controller circuit configured to: receive, at an input, a logic signal indicating that the responder bus node is ready to transfer the response data frame, and output a selection signal via the communication interface so as to cause the responder bus node to start the transfer of the response data frame.

Aspect 11: The commander bus node as recited in Aspect 10, wherein the controller circuit is further configured to evaluate the response data frame in order to determine a message index from the response data frame and to check whether the message index contained in the response data frame matches the message index contained in a previously sent data frame.

Aspect 12: The commander bus node as recited in Aspect 11, wherein the controller circuit is configured to initiate repeated transfer of the stored data frame if the message index contained in the response data frame does not match the message index contained in the previously sent data frame.

Aspect 13: The commander bus node as claimed in any of Aspects 10-12, wherein the controller circuit is further configured to evaluate the response data frame in order to determine a checksum from the response data frame and to check whether the checksum contained in the response data frame is correct.

Aspect 14: A method which comprises: receiving, by way of a commander bus node and from a responder bus node, a logic signal indicating that the responder bus node is ready to transfer a response data frame; outputting a selection signal so as to cause the responder bus node to start the transfer of the response data frame; receiving the response data frame; and sending a stored data frame, containing a command and a message index, to the responder bus node at the same time as receiving the response data frame.

Aspect 15: The method as recited in Aspect 14, further comprising: checking whether a message index contained in the response data frame matches a message index previously sent in a data frame to the responder bus node.

Aspect 16: The method as recited in Aspect 15, further comprising: resending the previously sent data frame to the responder bus node if the message index contained in the response data frame does not match the message index previously sent to the responder bus node.

Aspect 17: The method as claimed in any of Aspects 14-16, further comprising: checking whether a checksum contained in the response data frame is correct, and if the checksum is incorrect, sending another data frame, containing a no operation command, to the responder bus node and receiving the response data frame again.

Aspect 18: A system, comprising: a commander bus node; a responder bus node; a plurality of bus lines connecting a communication interface of the commander bus node to a communication interface of the responder bus node; and an additional signal line for data flow control, wherein the additional signal line connects the communication interface of the commander bus node to the communication interface of the responder bus node, wherein the responder bus node is configured to output, to the additional signal line, a logic signal indicating that a data frame is ready for transfer, and wherein the commander bus node is configured to start a data transfer based on the logic signal.

Aspect 19: The system as recited in Aspect 18, wherein the communication interface of the commander bus node and the communication interface of the responder bus node are each a standard serial peripheral interface.

Aspect 20: A system configured to perform one or more operations recited in one or more of Aspects 1-19.

Aspect 21: An apparatus comprising means for performing one or more operations recited in one or more of Aspects 1-19.

Aspect 22: A non-transitory computer-readable medium storing a set of instructions, the set of instructions comprising one or more instructions that, when executed by a device, cause the device to perform one or more operations recited in one or more of Aspects 1-19.

Aspect 23: A computer program product comprising instructions or code for executing one or more operations recited in one or more of Aspects 1-19.

1. A responder bus node for a serial bus system, comprising:
a communication interface which is configured to receive a data frame from a commander bus node and to send a stored response data frame to the commander bus node;
a processor unit configured to:
evaluate the data frame in order to determine a command and a message index based on the data frame;
execute a function identified by the command, wherein, if the command is not a no operation command (NOP), executing the function provides one or more data words as a function response;
produce a new response data frame having a header field containing at least the message index and having a payload field containing at least the function response; and
update the stored response data frame with the new response data frame and output, at an output, a logic signal indicating that the stored response data frame, having been updated with the new response data frame, is ready for transfer.

2. The responder bus node as claimed in claim 1, wherein the communication interface is configured to receive a clock signal and a selection signal, and to send the stored response data frame to the commander bus node in sync with the clock signal as soon as the selection signal indicates a start of a transfer.

3. The responder bus node as claimed in claim 1, wherein the data frame has a header field that has an operation code representing the command, the message index, and a checksum.

4. The responder bus node as claimed in claim 1, wherein the payload field of the new response data frame has a checksum.

5. The responder bus node as claimed in claim 1,
wherein the processor unit is further configured to, if the command is a no operation command (NOP), provide no function response, and
to output, at the output, the logic signal indicating that the stored response data frame is ready for transfer without having been updated beforehand.

6. The responder bus node as claimed in claim 1, wherein a separate line is connected to the output.

7. The responder bus node as claimed in claim 1,
wherein the communication interface has a first in first out (FIFO) memory for each transfer direction, and
wherein the data frame is stored in a first FIFIO memory and the response data frame is stored in a second FIFO memory.

8. The responder bus node as claimed in claim 1, wherein the responder bus node is a radar monolithic microwave integrated circuit.

9. A method which comprises:
receiving, by way of a responder bus node, a data frame from a commander bus node;
evaluating the data frame in order to determine a command and a message index based thereon;
executing a function identified by the command to provide one or more data words as a function response, if the command is not a no operation command (NOP);
producing a new response data frame having a header field containing at least the message index and having a payload field containing at least the function response;
updating a stored response data frame with the new response data frame if the command is not an NOP;
outputting, at an output of the responder bus node, a logic signal indicating that the stored response data frame, having been updated with the new response data frame, is ready for transfer; and
sending, by way of the responder bus node, the stored response data frame to the commander bus node.

10. A commander bus node, comprising:
a communication interface configured to send a stored data frame, containing a command and a message index, to a responder bus node and to receive a response data frame from the responder bus node; and
a controller circuit configured to:
receive, at an input, a logic signal indicating that the responder bus node is ready to transfer the response data frame, and
output a selection signal via the communication interface so as to cause the responder bus node to start the transfer of the response data frame.

11. The commander bus node as claimed in claim 10, wherein the controller circuit is further configured to evaluate the response data frame in order to determine a message index from the response data frame and to check whether the message index contained in the response data frame matches the message index contained in a previously sent data frame.

12. The commander bus node as claimed in claim 11, wherein the controller circuit is configured to initiate repeated transfer of the stored data frame if the message index contained in the response data frame does not match the message index contained in the previously sent data frame.

13. The commander bus node as claimed in claim 10, wherein the controller circuit is further configured to evaluate the response data frame in order to determine a checksum from the response data frame and to check whether the checksum contained in the response data frame is correct.

14. A method which comprises:
receiving, by way of a commander bus node and from a responder bus node, a logic signal indicating that the responder bus node is ready to transfer a response data frame;
outputting a selection signal so as to cause the responder bus node to start the transfer of the response data frame;
receiving the response data frame; and
sending a stored data frame, containing a command and a message index, to the responder bus node at the same time as receiving the response data frame.

15. The method as claimed in claim 14, further comprising:
checking whether a message index contained in the response data frame matches a message index previously sent in a data frame to the responder bus node.

16. The method as claimed in claim 15, further comprising:
resending the previously sent data frame to the responder bus node if the message index contained in the response data frame does not match the message index previously sent to the responder bus node.

17. The method as claimed in claim 14, further comprising:
checking whether a checksum contained in the response data frame is correct, and
if the checksum is incorrect, sending another data frame, containing a no operation command, to the responder bus node and receiving the response data frame again.

18. A system, comprising:
a commander bus node;
a responder bus node;
a plurality of bus lines connecting a communication interface of the commander bus node to a communication interface of the responder bus node; and
an additional signal line for data flow control, wherein the additional signal line connects the communication interface of the commander bus node to the communication interface of the responder bus node,
wherein the responder bus node is configured to output, to the additional signal line, a logic signal indicating that a data frame is ready for transfer, and
wherein the commander bus node is configured to start a data transfer based on the logic signal.

19. The system as claimed in claim 18, wherein the communication interface of the commander bus node and the communication interface of the responder bus node are each a standard serial peripheral interface.
